(19) United States
(12) Patent Application Publication
(10) Pub. No.: US 2009/0046786 A1
(43) Pub. Date: Feb. 19, 2009

(54) SYSTEM AND METHOD OF OPERATING A MIMO SYSTEM

(75) Inventors: Timothy J. Moulsley, Caterham (GB); David K. Roberts, Crawley (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,432

(22) PCT Filed: Oct. 19, 2005
(86) PCT No.: PCT/IB05/53427

§ 371 Date: Apr. 18, 2007

(30) Foreign Application Priority Data
Oct. 23, 2004 (GB) 0423567.7

(51) Int. Cl. H04L 27/06; H04L 27/28

(52) U.S. Cl. 375/260; 375/340; 455/69

(57) ABSTRACT

A MIMO system comprising a transmitting station (10) for transmitting a plurality of encoded data streams and a receiving station (12) for receiving and for decoding the encoded data streams, the performance of the receiving station being dependent on the order in which the received encoded data streams are decoded, wherein information relating to the decoding order is determined at the transmitting station and is signalled to the receiving station.

The present invention relates to a MIMO (Multiple Input Multiple Output) system and to a method of operating a MIMO system.

In general, in a MIMO system a plurality of data streams sent using a plurality of antennas at the transmitter are intended for reception by a plurality of antennas at the receiver. Typically, decoding of the multiple data streams is facilitated by the existence of different transfer functions between each pair of transmit and receive antennas.

EE492M Final Project Report “MIMO Capacity and Performance Comparison between D-Blast and V-Blast” by Zhang Rui (available at http://www.stanford.edu/˜engp9824/Websites/EE492M%20Final%20Project% 20Report.pdf), remarks that wireless communication systems using multi-element arrays (MEA's) at both the transmitter and receiver can achieve a high spectral efficiency in a high scattering environment. Under the assumption of no channel information being available at the transmitter, code architectures at the transmitters have been devised to achieve a great portion of high spectral efficiency promised by the information theory. Two known coding schemes proposed by G. J. Foschini in “Layered Space-Time Architecture for Wireless Communication in a Fading Environment when using Multi-Element Antennas”, Bell Labs Tech. J., pp. 41-59, Autumn 1996, are known as D-BLAST and V-BLAST. In both schemes total information rates are divided into parallel one-dimensional sub-streams with equal rate, which are separately coded and modulated for transmission. The key difference between D-BLAST and V-BLAST transmission is that in V-BLAST, each sub-stream is assigned with a fixed antenna for transmission while in D-BLAST, each sub-stream signal is transmitted over all antennas with a periodic time hopping pattern assigned by a stream hopping rotator. D-BLAST exploits spatial diversity due to multiple antenna transmission of each sub-stream signal and thus provides a higher outage capacity than V-BLAST. Outage capacity is relevant when a channel is randomly fluctuating but fixed for the duration of a code word. Outage capacity can be roughly understood as the rate below which arbitrarily reliable transmissions are possible for a pre-specified percentage of channel realisations.

The decoding process for D-BLAST and V-BLAST at the receiver has a key difference. For V-BLAST, it is possible to find an optimum order of decoding for each received sub-stream data while for D-BLAST, the order of decoding at the receiver has been determined by the stream rotator at the transmitter. Except for this, both D-BLAST and V-BLAST decoding processes are similar: each sub-stream is independently decoded (using either a Minimum Mean Square Error (MMSE) or zero forcing (ZF) algorithm) and then subtracted from the received signal in order to reduce the interference for decoding subsequent sub-streams. In V-BLAST, each sub-stream can only possess a fixed decoding order. Therefore, the achievable outage capacity in V-BLAST is limited by the sub-stream that has the worst average Signal to Interference and Noise Ratio (SINR). In contrast, each sub-stream in D-BLAST contains equal portions of data that can have all possible decoding orders. This leads to a SINR averaging effect in decoding each sub-stream and as a result, a higher outage capacity can be achieved than V-BLAST. Since the order of decoding for each sub-stream in D-BLAST is determined by the transmitter stream rotator, the best order of decoding needs to be fed back to the transmitter if further improvement of ZF detection is required.

“Asymptotical Analysis of the Outage Capacity of Rate-Tailored BLAST” Hao Zhang and Tommy Guess, IEEE Global Communications Conference, Dec. 1-5, 2003, San Francisco, Calif. compares Rate Tailored (RT)-BLAST with V-BLAST and another variant of BLAST, called H-BLAST. It is mentioned that one advantage of RT-BLAST over H-BLAST is a receiver with lower computational complexity because it does not need to perform optimal ordering. Further, this article mentions that the two main points of difference between RT-BLAST and H-BLAST are that the sub-channel rates of the transmitting antennas need not equal each other; indeed these rates are optimised in the case of RT-BLAST; and that the decoding order from the K layers is fixed at the receiver; this means that RT-BLAST has a lower complexity than H-BLAST which has the overhead of determining the optimal order for decoding the layers. Both RT-BLAST and H-BLAST utilise one-dimensional codes on all sub-channels, one for each transmitting antenna.

Typically, the channel state (for example channel transfer functions and noise and interference levels at the receiver antennas) is assumed to be known at the receiver but this may not be the case at the transmitter.

Under the assumption that no channel state information is available at the transmitter, it is appropriate to map a data stream to each antenna and arrange for the characteristics of the signals from each antenna to be similar, for example in terms of power and data rate. The data stream may also be cycled across all antennas in turn.

By making limited channel state information available at the transmitter (for example magnitude of each channel transfer function), then characteristics of the signals from each antenna can be adjusted accordingly. For example if the channel transfer functions from a particular transmit antenna show a low gain, then one or more of the power, modulation and coding scheme could be adjusted to optimise performance. One optimisation criterion could be to maximise the data rate achieved for a given total transmitted power. One example of such a scheme is known as PARC (Per-Antenna Rate Control). A further generalisation is known as S-PARC (Selective PARC), in which outputs from one or more of the transmitter antennas may be disabled. Typically, the disabled antennas would be the ones only capable of supporting low-rate data streams.

If detailed channel state information is available at the transmitter, then a form of spatial multiplexing can be used, in which a number of spatial transmission streams are created by feeding each transmit antenna with a weighted copy of a signal derived from each data stream. The transmitter weights may be derived taking into account (1) the channel transfer functions, (2) the noise levels at each receiving antenna, and (3) the processing assumed to be used at the receiver. For example, the received streams can be formed from a linear combination of the signals from each receiver antenna. Different data rates may also be selected for each spatial transmission stream. One possibility is to choose transmitter and receiver weights to create orthogonal spatial transmission streams. Another possibility is to choose weights which minimise the mean square error between the transmitted and received signals.

As an alternative to linear techniques, non-linear techniques such as successive interference cancellation (SIC) may be implemented. This is intended to reduce the effects of interference between transmitted data streams. Typically, one data stream is selected to be decoded (often the one with the highest Signal to Noise ratio (SNR) or Signal to Interference Ratio (SIR) and together with the relevant channel transfer functions, the resulting information is used to make an estimate of the received waveforms corresponding to that data stream. These waveforms can then be subtracted from the signals received by each antenna. Then another data stream is decoded, and the procedure repeated until all the data is decoded. This kind of scheme is effective, provided no (or very few) decoding errors are made. Therefore the procedure may be iterative, with the aim of correcting decoding errors made in previous iterations. Alternatively, soft estimates of the received waveforms may be subtracted, which reduces the error propagation effect.

In general the format at the transmitter may depend on processing assumed at the receiver. For example, in the case of SIC, the transmitter can better optimise performance if the order of decoding each data stream is known, or at least if the receiver algorithm for choosing the order is known. Thus the decoding order could be agreed in advance, or could be on the basis of SIR. In general the receiver can determine the optimum decoding order by testing all possibilities.

In the general case, the problem of determining the best decoding order at the receiver can be considered to be equivalent to determining the order in which code words (or parts of code words) should be decoded.

In some cases, for example SIC, it may be a complex computational task for the receiver to find the optimum decoding order. In such cases the computational task would cause a high power consumption which for a mobile station would lead to a shorter battery life.

An object of the present invention is to optimise the decoding order in a MIMO receiver.

According to one aspect of the present invention there is provided a MIMO system comprising a first apparatus having means for transmitting a plurality of encoded data streams and a second apparatus having means for receiving and means for decoding the encoded data streams, the performance of the second apparatus being dependent on the order in which the received encoded data streams are decoded, further comprising, at the first apparatus, means for determining information relating to the decoding order and means for transmitting the determined information to the second apparatus, and at the second apparatus, means for selecting a decoding order in response to the information relating to the decoding order received from the transmitting apparatus.

According to a second aspect of the present invention there is provided a method of operating a MIMO system comprising a first apparatus transmitting a plurality of encoded data streams, and a second apparatus receiving and decoding the encoded data streams, the performance of the second apparatus being dependent on the order in which the received data streams are decoded, further comprising the first apparatus determining information relating to decoding order and signalling the information to the second apparatus, and the second apparatus selecting a decoding order in response to receiving the information relating to decoding order.

By the transmitting station deciding on the decoding order and communicating the decoding order to the receiving station the power consumption in the receiver is reduced thus extending battery life.

The information relating to the decoding order may be prescriptive or may assist in determining the decoding order.

According to a third aspect of the present invention there is provided an apparatus for transmitting data in a MIMO system, comprising means for transmitting a plurality of encoded data streams to a receiving apparatus, means for determining information relating to decoding order of the data streams, and means for transmitting the determined information to the receiving apparatus.

According to a fourth aspect of the present invention there is provided an apparatus for receiving from a transmitting apparatus in a MIMO system, comprising means for receiving a plurality of encoded data streams, decoding means for decoding the plurality of encoded data streams, wherein the performance of the decoding means is dependent on the order in which the encoded data streams are decoded, and means for selecting a decoding order in response to information relating to decoding order received from the transmitting apparatus.

The present invention will now be described, by way of example, with reference to the accompanying drawings, wherein:

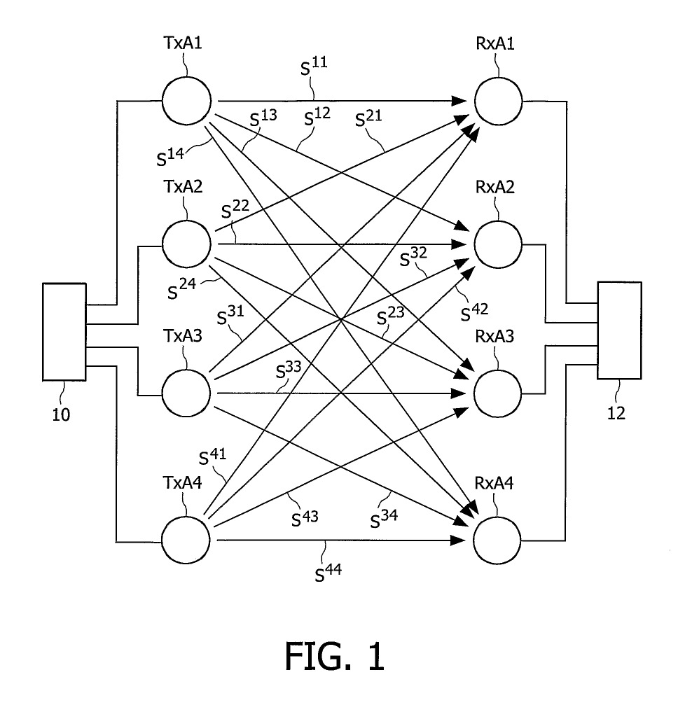

FIG. 1 illustrates diagrammatically the transmission paths between equal numbers of transmit and receive antennas in a MIMO system,

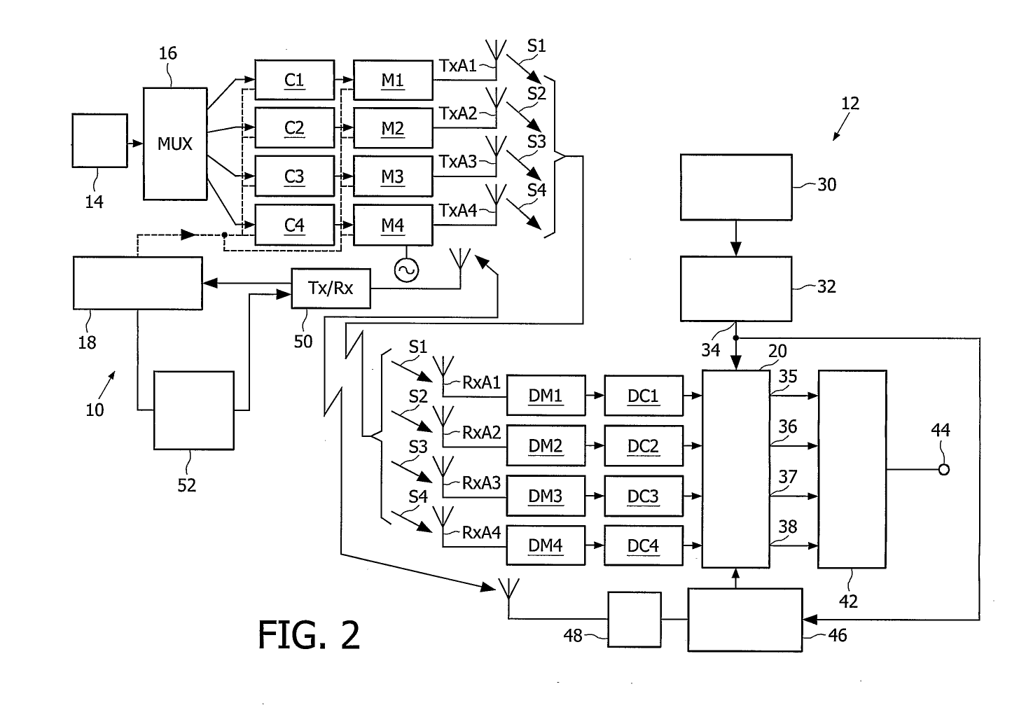

FIG. 2 is a block schematic diagram of one embodiment of a MIMO system made in accordance with the present invention, and

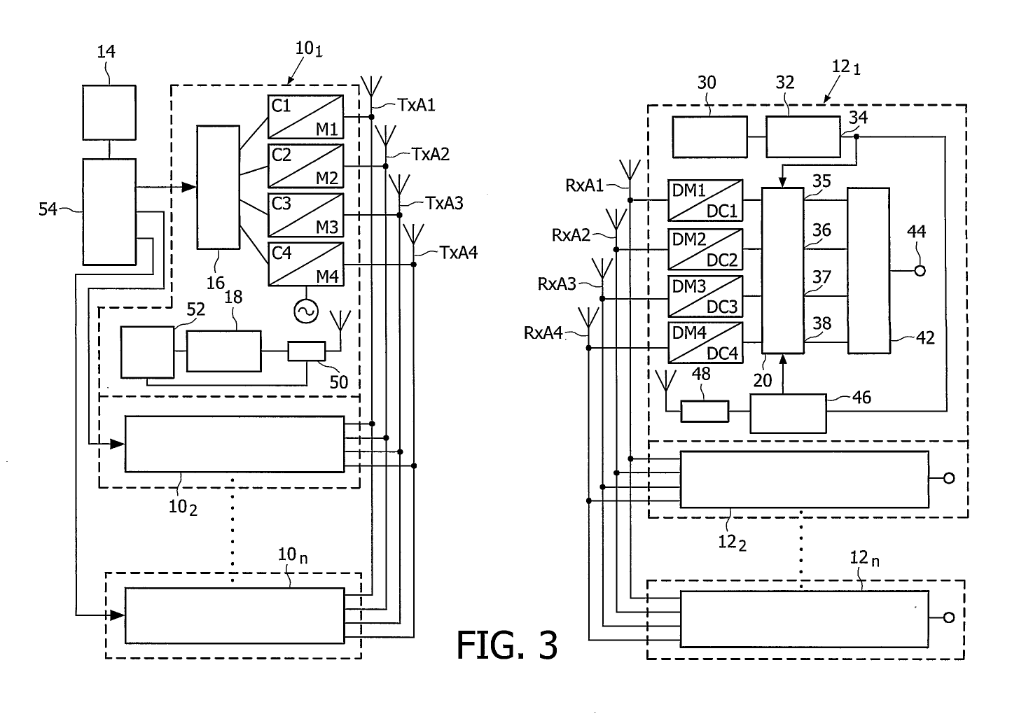

FIG. 3 is a block schematic diagram of a second, orthogonal frequency division multiplex (OFDM), embodiment of a MIMO system made in accordance with the present invention.

In the drawings the same reference numerals have been used to identify corresponding features.

Referring to FIG. 1, the illustrated system comprises a transmitting station 10 having four transmit antennas TxA1 to TxA4 and a receiving station 12 having four receive antennas RxA1 to RxA4 spatially separated from each other. Each of the transmit antennas TxA1 to TxA4 transmits a different respective data stream, referenced S¹ to S⁴, which is received by the receive antennas RxA1 to RxA4. For convenience the versions of the received signals will be referenced S^{ij} where “i” is the transmitter station antenna and “j” is the receiving station antenna. The received versions of S¹ at the four antennas RxA1 to RxA4 are S¹¹, S¹², S¹³, S¹⁴, respectively. Similarly the received versions of S² are S²¹, S²², S²³, S²⁴, of S³ are S³¹, S³², S³³, S³⁴ and of S⁴ are S⁴¹, S⁴², S⁴³, S⁴⁴. Thus in FIG. 1 the total of the signals received by each of the receive antennas is as follows:

Antenna RxA1=S¹¹+S²¹+S³¹+S⁴¹

Antenna RxA2=S¹²+S²²+S³²+S⁴²

Antenna RxA3=S¹³+S²³+S³³+S⁴³

Antenna RxA4=S¹⁴+S²⁴+S³⁴+S⁴⁴

Typically the receiving station 12 will possess means for determining the channel transfer functions relating the transmitted signals to their received versions at each of the receive antennas RxA1 to RxA4 that is relating S¹ to S¹¹, S¹², S¹³, S¹⁴, S² to S²¹, S²², S²³, S²⁴, S³ to S³¹, S³², S³³, S³⁴ and S⁴ to S⁴¹, S⁴², S⁴³, S⁴⁴. This permits the receiving station 12 to recover respective data streams algebraically because for example in the case of flat fading there are 4 simultaneous equations and four unknowns. Briefly in one method the best estimate of one of the data streams is obtained and a symbol is reconstructed. Then by using SIC techniques the contribution due to this symbol is subtracted from the signals received. This improves the signal to noise ratio of estimate of the remaining symbols and the process is repeated using the estimate with the next best SNR. This cycle is repeated until all the symbols have been recovered.

Although an equal number of transmit and receive antennas are shown, this is not an essential requirement because the number of transmit antennas defines the number of unknowns in the simultaneous equations. However in order to solve these simultaneous equations there must be a minimum of an equal number of receive antennas although in a mobile environment there are advantages in having more receive antennas just in case any become unuseable due to propagation problems.

When decoding signals it is advantageous to know the preferred decoding order in order to reduce the amount of computation involved and thereby save power at the receiver. The method in accordance with the present invention relates to the transmitting station determining, on the basis of channel state information (CSI), the order in which the data stream should be decoded to give the best performance, for example in terms of code word error rate. In one embodiment of the present invention, the CSI is determined at the receiving station and is relayed to the transmitting station. In an alternative embodiment, a transmitting station having a transceiver operating in a Time Division Duplex (TDD) mode and having a fast turn around between uplink and downlink transmissions, may, at least in principle, measure the channel by way of signals it receives and treats the channel measurements as being valid for its next transmission.

Referring to FIG. 2, the transmitting station 10 comprises a data source 14 coupled to an input of a multiplexer 16. The number of output signal paths from the multiplexer 16 corresponds to the number, in this case four, of transmit antennas TxA1 to TxA4. The respective bit rate signal streams in each signal path are coded for error correction in coders C1 to C4 and are modulated onto the same frequency carrier in respective modulators M1 to M4 to produce respective symbol rate signals. These signals are applied to their respective transmit antennas TxA1 to TxA4.

A processor 18 controls the operation of the transmitting station 10 including the coders C1 to C4 and the modulators M1 to M4. By way of example the processor 18 can adjust the number of bits per symbol in a respective modulator in response to the quality of the respective radio channel, for example a good channel can have a high order modulation and conversely a poor channel can have a low order modulation. Additionally the processor 18 can be involved in deciding the decoding order at the receiving station. This will be described in greater detail later.

The receiving station 12 comprises the four receive antennas RxA1 to RxA4, each of which is coupled to a respective series connected arrangement of a demodulator DM1 to DM4 and a decoder DC1 to DC4. A processor 20 has a plurality of inputs, four of which are connected respectively to outputs of the decoders DC1 to DC4. The processor 20 functions to disentangle the signals and to effect decoding decisions using SIC. In carrying-out these functions account is taken of information relating to the state of each transmission channel and the decoding order suggested by the transmitting station.

A channel state estimator 30 monitors criteria, for example signal strength measurements, affecting the respective radio channels and periodically updates information held in a channel information store 32. The channel state may be estimated using training data or code words, such as synchronising code words, transmitted by the transmitting station on a down link. An output 34 of the channel information store 32 is coupled to the processor 20.

The processor 20 has four outputs 35 to 38, respectively, providing estimates of each of the four data streams at the outputs of the multiplexer 16 of the transmitting station 10. These estimates are supplied to respective inputs of a demultiplexer 42 which has a data output 44.

Information relating to the quality of the radio channels, for example the transfer function and the SIR for each radio path is supplied by the channel information store 32 to a modulator/demodulator (DEMOD) 46 in which it is modulated on a carrier and transmitted by a transmitter section of a transceiver 48 to the transmitting station 10.

The channel state information is received and demodulated by a receiving section of a transceiver 50. An output of the transceiver 50 is applied to an input of the processor 18. The processor 18 computes the received data in accordance with pre-stored software and supplies an output to a stage 52 which determines the decoding order in the receiving station 12. The information is received by the transceiver 48, demodulated in the DEMOD 46 and supplied as a “decoding order” signal to the processor 20 which uses this signal when determining the order of decoding. The decoding order signal is used by the processor 20 as hinting at the preferred order of decoding subject to any locally determined factors to the contrary.

The information received by the transceiver 48 may comprise partial information which is used by the receiving station to help it determine the decoding order or set of possible decoding orders, for example specifying a subset of possible code words which should be considered for decoding at each step.

In the event of there being no channel state information the processor 18 treats all the channels as being the same.

In the embodiment of the OFDM system shown in FIG. 3 each data stream is transmitted on a number of sub-carriers, from a respective antenna. The number of sub-carriers for an OFDM system may be quite large and is typically a power of 2, for example 64 (2⁶), 128 (2⁷) . . . 1024 (2¹⁰). The illustrated system comprises a plurality of transmitting units 10₁, 10₂ to 10ₙ, where n is an integer, of a type described with reference to FIG. 2 but with the difference that the data source 14 is connected to a multiplexer 54 having outputs connected respectively to the multiplexers of each transmitting unit 10₁, 10₂ to 10ₙ. In operation each transmitting unit 10₁, 10₂ to 10ₙ produces data streams but on different sub-carriers. Correspondingly numbered outputs of the transmitting units are coupled to the same transmit antenna TxA1 to TxA4.

Similarly there is a corresponding plurality of receiving units 12₁ to 12ₙ, where n is an integer, of the type described with reference to FIG. 2 having corresponding inputs coupled respectively to the antennas RxA1 to RxA4.

In a non-illustrated embodiment of the present invention a code word may be distributed in both time and across sub-carriers.

In the present specification and claims the word “a” or “an” preceding an element does not exclude the presence of a plurality of such elements. Further, the word “comprising” does not exclude the presence of other elements or steps than those listed.

The inclusion of reference signs in parentheses in the claims is intended to aid understanding and is not intended to be limiting.

From reading the present disclosure, other modifications will be apparent to persons skilled in the art. Such modifications may involve other features which are already known in the design, manufacture and use of MIMO systems and component parts therefor and which may be used instead of or in addition to features already described herein.

1. A MIMO system comprising a first apparatus (10) having means (M1-4) for transmitting a plurality of encoded data streams and a second apparatus (12) having means (DM1-4) for receiving and means (DC1-4) for decoding the encoded data streams, the performance of the second apparatus (12) being dependent on the order in which the received encoded data streams are decoded, further comprising, at the first apparatus (10), means (52) for determining information relating to the decoding order and means (50) for transmitting the determined information to the second apparatus (12), and at the second apparatus (12), means (20) for selecting a decoding order in response to the information relating to the decoding order received from the transmitting apparatus (10).

2. A system as claimed in claim 1, characterised in that the second apparatus (12) has a transmitter (48) adapted to signal channel information to the first apparatus (10), and at the first apparatus (10) the means (52) for determining information relating to the decoding order is responsive to the channel information transmitted by the second apparatus (12).

3. A system as claimed in claim 1, characterised in that the determined information is partial information and in that the means (20) for selecting a decoding order is adapted to use the partial information to determine a decoding order or set of possible decoding orders.

4. A method of operating a MIMO system comprising a first apparatus (10) transmitting a plurality of encoded data streams, and a second apparatus (12) receiving and decoding the encoded data streams, the performance of the second apparatus (12) being dependent on the order in which the received data streams are decoded, further comprising the first apparatus (10) determining information relating to decoding order and signalling the information to the second apparatus (12), and the second apparatus (12) selecting a decoding order in response to receiving the information relating to decoding order.

5. A method as claimed in claim 4, characterised by the second apparatus (12) signalling channel information to the first apparatus (14) and by the first apparatus (10) determining the information relating to decoding order based on said channel information.

6. A method as claimed in claim 4, characterised in that the determined information is partial information and in that the second apparatus (12) determines a decoding order or set of possible decoding orders using the partial information.

7. An apparatus (10) for transmitting data in a MIMO system, comprising means (M1-4) for transmitting a plurality of encoded data streams to a receiving apparatus (12), means (52) for determining information relating to decoding order of the data streams, and means (50) for transmitting the determined information to the receiving apparatus (12).

8. An apparatus (10) as claimed in claim 7, characterised in that the determined information is partial information.

9. An apparatus (10) as claimed in claim 7, characterised in that the means (52) for determining information relating to decoding order of the data streams is responsive to channel information received from the receiving apparatus (12).

10. An apparatus (10) as claimed in claim 7, characterised in that the means (10₁, 10₂ to 10ₙ) for transmitting is adapted to transmit the encoded data streams as OFDM signals.

11. An apparatus (10) as claimed in claim 7, comprising means (C1-4, M1-4) adapted to distribute a code word in both time and across sub-carriers.

12. An apparatus (12) for receiving from a transmitting apparatus (10) in a MIMO system, comprising means (DM1-4) for receiving a plurality of encoded data streams, decoding means (DC1-4) for decoding the plurality of encoded data streams, wherein the performance of the decoding means (DC1-4) is dependent on the order in which the encoded data streams are decoded, and means (20) for selecting a decoding order in response to information relating to decoding order received from the transmitting apparatus (10).

13. An apparatus (12) as claimed in claim 12, characterised in that the information relating to decoding order is partial information and in that the means (20) for selecting a decoding order is adapted to use the partial information to select the decoding order or set of possible decoding orders.

14. An apparatus (12) as claimed in claim 12, characterised by a transmitter (48) adapted to signal channel information to the first apparatus (10).

15. An apparatus (12) as claimed in claim 12, characterised by means (DC1 to DC4) for decoding a code word and means (20) for estimating the received signal due to this code word and successive interference cancellation means (20) for reconstructing and subtracting the received signal due to the code word from the total received signal.

16. An apparatus (12) as claimed in claim 12, adapted to receive the encoded data streams as OFDM signals on a plurality of sub-carriers.
